(19) United States
(12) Patent Application Publication
(10) Pub. No.: US 2013/0262826 A1
(43) Pub. Date: Oct. 3, 2013

(54) APPARATUS AND METHOD FOR DYNAMICALLY MANAGING MEMORY ACCESS BANDWIDTH IN MULTI-CORE PROCESSOR

(71) Applicants: Alexander Gendler, Kiriat Motzkin (IL); Larisa Novakovsky, Haifa (IL); George Leifman, Haifa (IL); Dana Rip, Haifa (IL)

(72) Inventors: Alexander Gendler, Kiriat Motzkin (IL); Larisa Novakovsky, Haifa (IL); George Leifman, Haifa (IL); Dana Rip, Haifa (IL)

(21) Appl. No.: 13/991,619

(22) PCT Filed: Oct. 6, 2011
(86) PCT No.: PCT/US2011/055122

§ 371 Date: Jun. 4, 2013

(51) Int. Cl. G06F 9/38

(52) U.S. Cl. CPC G06F 9/3802
USPC 712/207

(57) ABSTRACT

An apparatus and method are described for performing history-based prefetching. For example a method according to one embodiment comprises: determining if a previous access signature exists in memory for a memory page associated with a current stream; if the previous access signature exists, reading the previous access signature from memory; and issuing prefetch operations using the previous access signature.

### FIELD OF THE INVENTION

This invention relates generally to the field of computer processors. More particularly, the invention relates to an apparatus and method for dynamically managing memory bandwidth in a multi-core processor.

### DESCRIPTION OF THE RELATED ART

Many modern microprocessors have large instruction pipelines that facilitate high speed operation. “Fetched” program instructions enter the pipeline, undergo operations such as decoding and executing in intermediate stages of the pipeline, and are “retired” at the end of the pipeline. When the pipeline receives a valid instruction and the data needed to process the instruction each clock cycle, the pipeline remains full and performance is good. When valid instructions are not received each cycle and/or when the necessary data is not available the pipeline may stall and performance can suffer. For example, performance problems can result from branch instructions in program code. If a branch instruction is encountered in the program and the processing branches to the target address, a portion of the instruction pipeline may have to be flushed, resulting in a performance penalty. Moreover, even with sequentially executed (i.e., non-branch) instructions, modern microprocessors are much faster than the memory where the program is kept, meaning that the program's instructions and data cannot be read fast enough to keep the microprocessor busy.

System performance may be enhanced and effective memory access latency may be reduced by anticipating the needs of a processor. If the data and instructions needed by a processor in the near future are predicted, then the data and instructions can be fetched in advance or “prefetched”, such that the data/instructions are buffered/cached and available to the processor with low latency. A prefetcher that accurately predicts a READ request (such as, for example, for a branch instruction) and issues it in advance of an actual READ can thus, significantly improve system performance. Prefetchers can be implemented in a CPU or in a chipset, and prefetching schemes have been routinely used for both.

Prefetching may be performed at various levels of a CPU's cache hierarchy. For example, some current x86-based processors include a Level 2 (“L2” or “MLC”) cache stream prefetcher to reduce the number of L2 and lower level (e.g., “L3” or “LLC”) cache misses. The stream prefetcher predicts future accesses within a memory page based on the order of accesses within that page and the distance between subsequent accesses.

In a multi-core processor, each processor core must share a portion of the overall bandwidth for accesses to main memory (i.e., memory bandwidth is a shared resource). Consequently, there may be situations where overly-aggressive prefetching of one core consumes most of the shared memory bandwidth, thereby causing the demand requests of other cores to stall and reducing performance.

As such, what is needed is a more intelligent method for controlling prefetching aggressiveness to improve processor performance.

### BRIEF DESCRIPTION OF THE DRAWINGS

A better understanding of the present invention can be obtained from the following detailed description in conjunction with the following drawings, in which:

FIGS. 1a-b illustrate one embodiment of a processor architecture for performing dynamic throttling of prefetch aggressiveness.

FIG. 2 illustrates a method for performing dynamic throttling of prefetch aggressiveness.

FIG. 3 illustrates a computer system on which embodiments of the invention may be implemented.

FIG. 4 illustrates another computer system on which embodiments of the invention may be implemented.

### DETAILED DESCRIPTION

In the following description, for the purposes of explanation, numerous specific details are set forth in order to provide a thorough understanding of the embodiments of the invention described below. It will be apparent, however, to one skilled in the art that the embodiments of the invention may be practiced without some of these specific details. In other instances, well-known structures and devices are shown in block diagram form to avoid obscuring the underlying principles of the embodiments of the invention.

As mentioned above, limited memory bandwidth in multi-core architectures creates situations where the aggressive prefetching of one core consumes most of the memory bandwidth. As a result, the demand requests of other cores cannot be served, resulting in a performance hit.

One embodiment of the invention addresses these problems by controlling the aggressiveness of core prefetching. Specifically, in one embodiment, a throttling threshold value is set and prefetching is throttled down or disabled when the current ratio of the number of mid-level cache (MLC) hits over the number of demands for the current detector is below the specified throttling threshold value. Prefetching may be throttled back up when this ratio rises above the specified throttling threshold value.

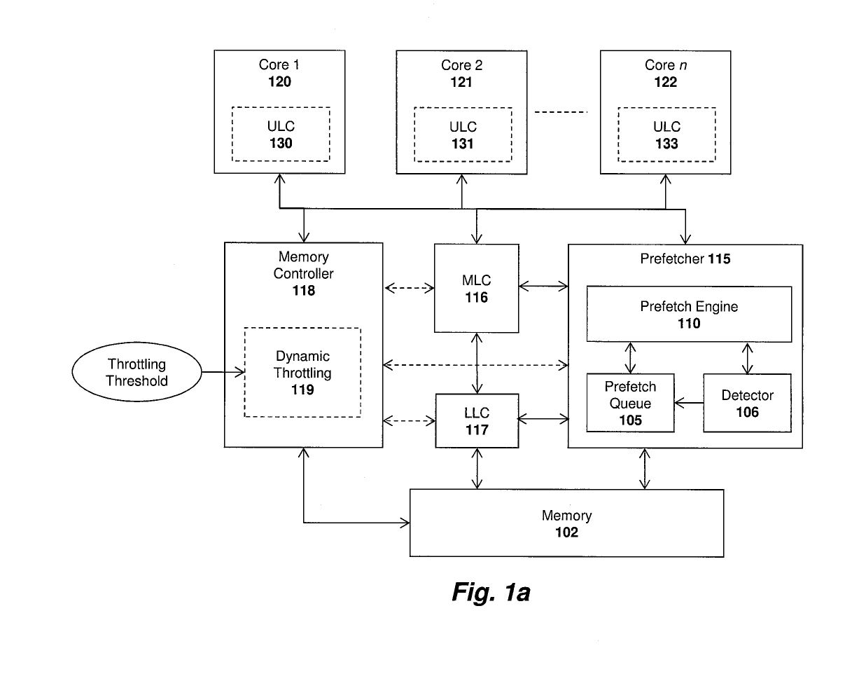

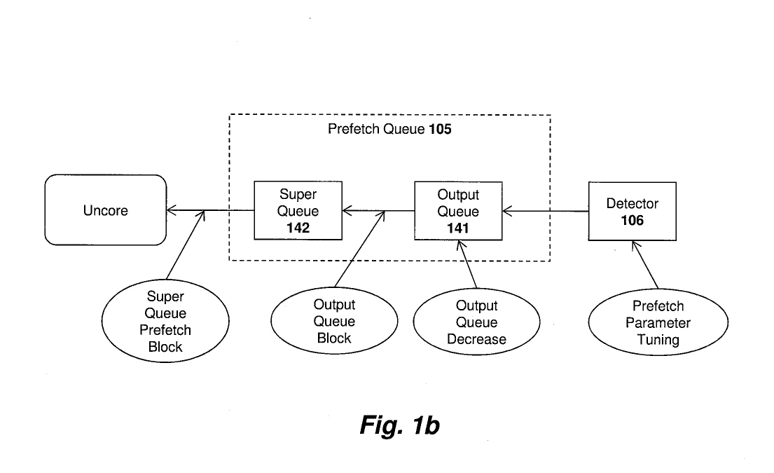

FIG. 1a illustrates an exemplary processor architecture on which embodiments of the invention may be implemented. The architecture includes a plurality of processor cores 120-122 each containing its own upper level cache (“ULC” or sometimes referred to as a level 1 (“L1”) cache) 130-133, respectively, for caching instructions and data. The architecture also includes a memory controller 118 with dynamic throttling logic 119 for implementing the dynamic throttling techniques described herein. A mid-level cache (“MLC” or sometimes referred to as a level 2 (“L2”) cache) and a lower level cache 117 are employed for caching instructions and data according to a specified cache management policy. The cache management policy may comprise an inclusive policy in which any cache line stored in a cache relatively higher in the hierarchy (e.g., the ULC) is also present in a cache further down the hierarchy (e.g., in the MLC 116 or LLC 117). Alternatively, an exclusive cache management policy may be implemented in which a cache line is stored in only one cache in the hierarchy at a time (excluding all other caches from storing the cache line). The underlying principles of the invention may be implemented on processors having either inclusive or exclusive cache management policies.

The architecture shown in FIG. 1a also includes a prefetch unit 115 with a prefetch engine 110 which executes an algorithm for prefetching instructions from memory 102 and storing the prefetched instructions within a prefetch queue 105 from which they may be read into one of the various caches 116-117, 130-133 prior to execution by one of the cores 120-122. As it is well understood by those of skill in the art, the prefetch engine 110 implements an algorithm which attempts to predict the instructions which each core will require in the future and responsively pre-fetches those instructions from memory 102.

To this end, the prefetcher 115 includes detector logic 106 which may include multiple detectors for learning and identifying prefetch candidates. The detector 106 of one embodiment comprises a detector table, with each entry in the table identifying a specified contiguous physical address region of memory 102 from which prefetch operations are to be executed. The detector identifies a particular region with a region address and includes state information for learning and identifying prefetch candidates.

In one embodiment, the dynamic throttling logic 119 controls the prefetch engine 110 to throttle up or down prefetch requests in response to a specified throttling threshold. Specifically, in one embodiment, the throttling threshold is set at one of the following values: (1) no throttle (throttling as described herein is disabled); (2) 25% or ¼ (low throttle); (3) 50% or ½ (medium throttle); and (4) 75% or ¾ (high throttle). In one embodiment, the dynamic throttling logic 119 monitors the number of MLC cache hits in relation to the number of demands generated by the cores and, if the ratio of the number of MLC cache hits to the number of demands is below the current specified throttling threshold, then the dynamic throttling logic 119 signals to the prefetcher 115 to cease any new prefetch requests. In one embodiment, the above techniques are implemented only when the current detector has more than one outstanding demand.

It should be noted that the underlying principles of the invention are not limited to the particular cache layout shown in FIG. 1a. For example, in an alternative embodiment, each processor core may have its own dedicated MLC and/or LLC. In yet another embodiment, a single ULC may be shared between the cores 120-122. Various other architectural modifications may be implemented while still complying with the underlying principles of the invention.

As illustrated in FIG. 1b, in one embodiment, the prefetch queue 105 comprises an output queue 141 and a super queue 142. Prefetched instructions flow along the prefetch pipeline from the detector 106 to the output queue 141, to the super queue 142. In one embodiment, various points in the prefetching pipeline may be controlled to control prefetch aggressiveness. For example, as indicated in FIG. 1b, prefetch parameters may be controlled at the detector 106. The output queue 141 may also be decreased in size or blocked and/or the output of the super queue 142 may be dropped.

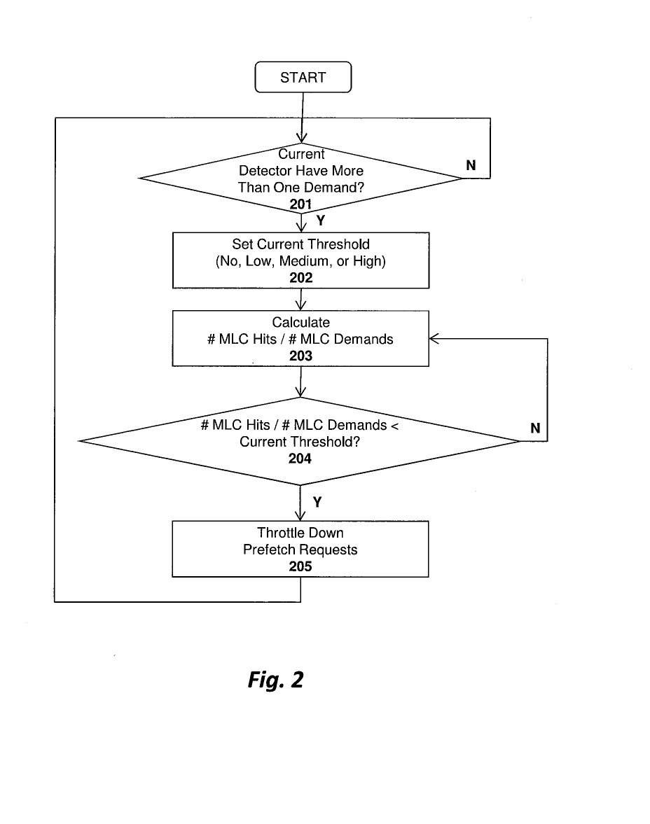

A method according to one embodiment of the invention is illustrated in FIG. 2. The method may be implemented using the microprocessor architecture shown in FIGS. 1a-b but is not necessarily limited to any particular microprocessor architecture.

At 201 a determination is made as to whether the current prefetch detector has more than one demand pending. If not, then the current throttling threshold is set to No Throttle at 206 (i.e., because if only a single demand is pending then the problems associated with aggressive prefetching described above are not present). If, however, the current detector has more than one demand, then at 202, the throttling threshold may be set at (1) 25% or ¼ (low throttle); (2) 50% or ½ (medium throttle); or (3) 75% or ¾ (high throttle).

At 203, the ratio of the number of MLC hits to the number of MLC demands is calculated and, at 204, this ratio is compared to the current throttling threshold. If the ratio is lower than the current throttling threshold, then at 205, steps are taken to throttle down prefetch requests. For example, in one embodiment, the prefetch unit will not issue new requests if the ratio of the number of MLC hits to the number of MLC demands is below the threshold.

In one embodiment, to reduce additional pressure on the memory controller, least recently used (LRU) hints are disabled from the cache management policy if the throttle level is set at low, medium or high. LRU hints are typically employed to identify least recently used cache lines for eviction. Disabling LRU hints in this embodiment will have the effect of reducing traffic on the communication ring connecting the cores 120-122 and help balance the system.

The following additional prefetch parameters may set in one embodiment of the invention:
The value of “double_mlc_window_watermark” may be set higher to cause the issuance of more MLC prefetch requests. In one embodiment, the double_mlc_window_watermark variable multiplies the possible number of prefetch request with parking in both the MLC 116 and LLC 117s.
The value of “llc_only_watermark” may be set higher, thereby forcing all prefetch request parking to the LLC 117 only.
Kick start may send 6 instead of 4 requests.

In one embodiment, the foregoing parameters are set as follows for each of the throttle thresholds:

No Throttle:

In one embodiment, the no throttle condition is implemented with “double_mlc_window_watermark” set to its higher value (e.g., 11), with “llc_only_watermark” set to its higher value (e.g., 14), and with 6 kick start requests.

Low Throttle:

In one embodiment, the low throttle condition is implemented with “double_mlc_window_watermark” set to its standard value (e.g., 6), with “llc_only_watermark” set to its standard value (e.g., 12), and with 4 kick start requests. In one embodiment, if the number of demands for the detector is higher than the threshold (default 2), then the MLC hit/demand ratio is checked to determine if it is below the ¼ threshold throttle value, as described above.

Medium Throttle:

In one embodiment, the medium throttle condition is implemented with “double_mlc_window_watermark” set to its standard value (e.g., 6), with “llc_only_watermark” set to its standard value (e.g., 12), and with 4 kick start requests. In one embodiment, if the number of demands for the detector is higher than the threshold (default 2), then the MLC hit/demand ratio is checked to determine if it is below the ½ threshold throttle value, as described above.

High Throttle:

In one embodiment, the high throttle condition is implemented with “double_mlc_window_watermark” set to its standard value (e.g., 6), with “llc_only_watermark” set to its standard value (e.g., 12), and with 4 kick start requests. In one embodiment, if the number of demands for the detector is higher than the threshold (default 2), then the MLC hit/demand ratio is checked to determine if it is below the ¾ threshold throttle value, as described above.

The specific values set forth above are used merely for the purposes of illustration of one specific embodiment of the invention. It should be noted, however, that the underlying principles of the invention are not limited to an implementation having these particular values.

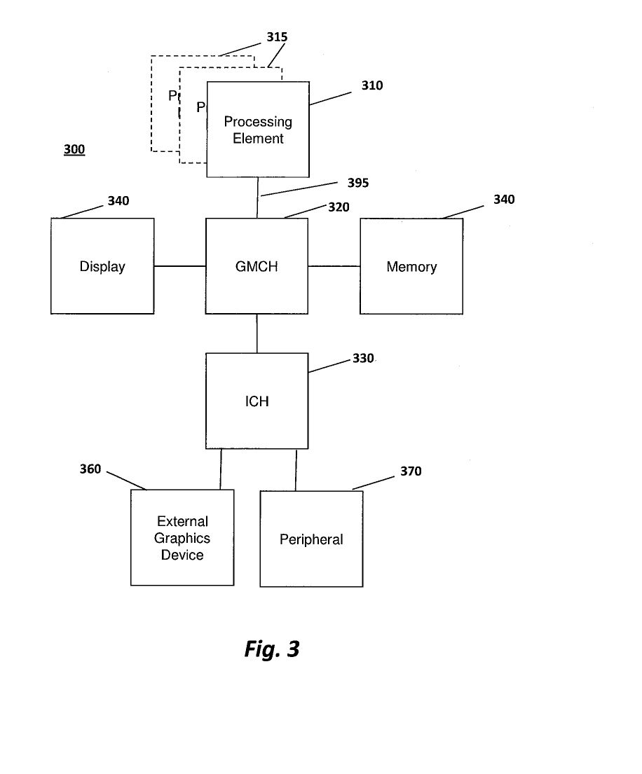

Referring now to FIG. 3, shown is a block diagram of a computer system 300 in accordance with one embodiment of the present invention. The system 300 may include one or more processing elements 310, 315, which are coupled to graphics memory controller hub (GMCH) 320. The optional nature of additional processing elements 315 is denoted in FIG. 3 with broken lines.

Each processing element may be a single core or may, alternatively, include multiple cores. The processing elements may, optionally, include other on-die elements besides processing cores, such as integrated memory controller and/or integrated I/O control logic. Also, for at least one embodiment, the core(s) of the processing elements may be multithreaded in that they may include more than one hardware thread context per core.

FIG. 3 illustrates that the GMCH 320 may be coupled to a memory 340 that may be, for example, a dynamic random access memory (DRAM). The DRAM may, for at least one embodiment, be associated with a non-volatile cache.

The GMCH 320 may be a chipset, or a portion of a chipset. The GMCH 320 may communicate with the processor(s) 310, 315 and control interaction between the processor(s) 310, 315 and memory 340. The GMCH 320 may also act as an accelerated bus interface between the processor(s) 310, 315 and other elements of the system 300. For at least one embodiment, the GMCH 320 communicates with the processor(s) 310, 315 via a multi-drop bus, such as a frontside bus (FSB) 395.

Furthermore, GMCH 320 is coupled to a display 340 (such as a flat panel display). GMCH 320 may include an integrated graphics accelerator. GMCH 320 is further coupled to an input/output (I/O) controller hub (ICH) 350, which may be used to couple various peripheral devices to system 300. Shown for example in the embodiment of FIG. 3 is an external graphics device 360, which may be a discrete graphics device coupled to ICH 350, along with another peripheral device 370.

Alternatively, additional or different processing elements may also be present in the system 300. For example, additional processing element(s) 315 may include additional processors(s) that are the same as processor 310, additional processor(s) that are heterogeneous or asymmetric to processor 310, accelerators (such as, e.g., graphics accelerators or digital signal processing (DSP) units), field programmable gate arrays, or any other processing element. There can be a variety of differences between the physical resources 310, 315 in terms of a spectrum of metrics of merit including architectural, microarchitectural, thermal, power consumption characteristics, and the like. These differences may effectively manifest themselves as asymmetry and heterogeneity amongst the processing elements 310, 315. For at least one embodiment, the various processing elements 310, 315 may reside in the same die package.

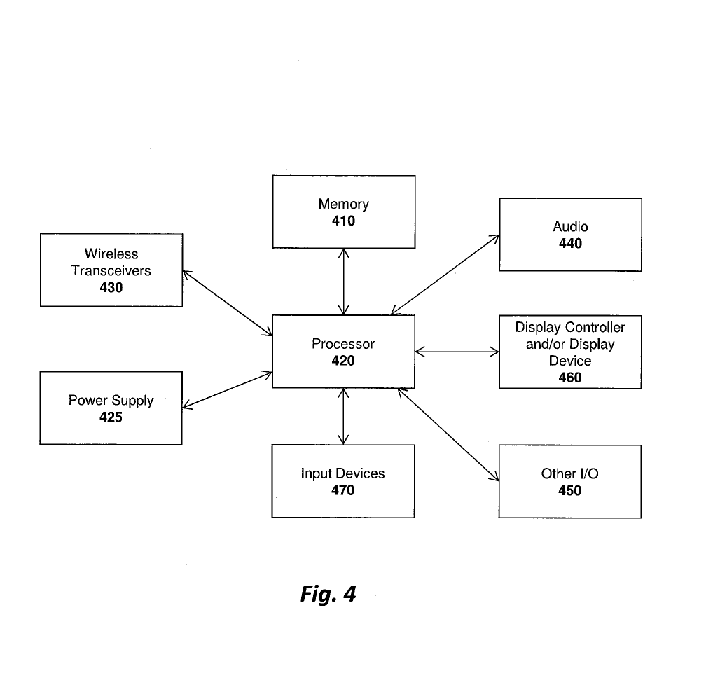

FIG. 4 is a block diagram illustrating another exemplary data processing system which may be used in some embodiments of the invention. For example, the data processing system 400 may be a handheld computer, a personal digital assistant (PDA), a mobile telephone, a portable gaming system, a portable media player, a tablet or a handheld computing device which may include a mobile telephone, a media player, and/or a gaming system. As another example, the data processing system 400 may be a network computer or an embedded processing device within another device.

According to one embodiment of the invention, the exemplary architecture of the data processing system 900 may used for the mobile devices described above. The data processing system 900 includes the processing system 420, which may include one or more microprocessors and/or a system on an integrated circuit. The processing system 420 is coupled with a memory 910, a power supply 425 (which includes one or more batteries) an audio input/output 440, a display controller and display device 460, optional input/output 450, input device(s) 470, and wireless transceiver(s) 430. It will be appreciated that additional components, not shown in FIG. 4, may also be a part of the data processing system 400 in certain embodiments of the invention, and in certain embodiments of the invention fewer components than shown in FIG. 45 may be used. In addition, it will be appreciated that one or more buses, not shown in FIG. 4, may be used to interconnect the various components as is well known in the art.

The memory 410 may store data and/or programs for execution by the data processing system 400. The audio input/output 440 may include a microphone and/or a speaker to, for example, play music and/or provide telephony functionality through the speaker and microphone. The display controller and display device 460 may include a graphical user interface (GUI). The wireless (e.g., RF) transceivers 430 (e.g., a WiFi transceiver, an infrared transceiver, a Bluetooth transceiver, a wireless cellular telephony transceiver, etc.) may be used to communicate with other data processing systems. The one or more input devices 470 allow a user to provide input to the system. These input devices may be a keypad, keyboard, touch panel, multi touch panel, etc. The optional other input/output 450 may be a connector for a dock.

Other embodiments of the invention may be implemented on cellular phones and pagers (e.g., in which the software is embedded in a microchip), handheld computing devices (e.g., personal digital assistants, smartphones), and/or touch-tone telephones. It should be noted, however, that the underlying principles of the invention are not limited to any particular type of communication device or communication medium.

Embodiments of the invention may include various steps, which have been described above. The steps may be embodied in machine-executable instructions which may be used to cause a general-purpose or special-purpose processor to perform the steps. Alternatively, these steps may be performed by specific hardware components that contain hardwired logic for performing the steps, or by any combination of programmed computer components and custom hardware components.

Elements of the present invention may also be provided as a computer program product which may include a machine-readable medium having stored thereon instructions which may be used to program a computer (or other electronic device) to perform a process. The machine-readable medium may include, but is not limited to, floppy diskettes, optical disks, CD-ROMs, and magneto-optical disks, ROMs, RAMs, EPROMs, EEPROMs, magnet or optical cards, propagation media or other type of media/machine-readable medium suitable for storing electronic instructions. For example, the present invention may be downloaded as a computer program product, wherein the program may be transferred from a remote computer (e.g., a server) to a requesting computer (e.g., a client) by way of data signals embodied in a carrier wave or other propagation medium via a communication link (e.g., a modem or network connection).

Throughout this detailed description, for the purposes of explanation, numerous specific details were set forth in order to provide a thorough understanding of the present invention. It will be apparent, however, to one skilled in the art that the invention may be practiced without some of these specific details. In certain instances, well known structures and functions were not described in elaborate detail in order to avoid obscuring the subject matter of the present invention. Accordingly, the scope and spirit of the invention should be judged in terms of the claims which follow.

What is claimed is:

1. A method for dynamically adjusting prefetch requests to improve performance in a multi-core processor comprising:
setting a current throttling threshold to one of a plurality of selectable threshold levels;
determining a ratio of a number of current mid-level cache (MLC) hits to MLC demands;
throttling down prefetch requests if the ratio of the number of current MLC hits to MLC demands is below the currently selected throttling threshold level.

2. The method as in claim 1 wherein the plurality of selectable threshold levels includes a low throttle level of 25% or ¼, a medium throttle level of 50% or ½ and the high throttle level comprises 75% or ¾.

3. The method as in claim 2 further comprising:
disabling least recently used (LRU) hints when the current threshold level is set at a low throttle level, medium throttle level, or high throttle level.

4. The method as in claim 1 further comprising:
determining if the current prefetch detector has more than one demand pending; and
if not, then setting the current throttling threshold level to No Throttle.

5. An apparatus for dynamically adjusting prefetch requests to improve performance in a multi-core processor comprising:
a mid-level cache (MLC) for caching instructions and data according to a specified cache management policy;
a prefetcher unit to prefetch instructions from memory, the instructions to be prefetched being identified by a prefetch detector;
a memory controller with dynamic throttling logic to perform the operations of:
setting a current throttling threshold to one of a plurality of selectable threshold levels;
determining a ratio of a number of MLC hits to MLC demands; and
throttling down prefetch requests if the ratio of the number of current MLC hits to MLC demands is below the currently selected throttling threshold level.

6. The apparatus as in claim 5 wherein the plurality of selectable threshold levels includes a low throttle level of 25% or ¼, a medium throttle level of 50% or ½ and the high throttle level comprises 75% or ¾.

7. The apparatus as in claim 6 wherein the memory controller disables least recently used (LRU) hints when the current threshold level is set at a low throttle level, medium throttle level, or high throttle level.

8. The method as in claim 1 wherein memory controller is configured to perform the additional operations of:
determining if the current prefetch detector has more than one demand pending; and
if not, then setting the current throttling threshold level to No Throttle.

9. A computer system comprising:
a display device;
a memory for storing instructions;
a multi-core processor for processing the instructions, the multi-core processor dynamically adjusting prefetch requests to improve performance by performing the operations of:
setting a current throttling threshold to one of a plurality of selectable threshold levels;
determining a ratio of a number of current mid-level cache (MLC) hits to MLC demands;
throttling down prefetch requests if the ratio of the number of current MLC hits to MLC demands is below the currently selected throttling threshold level.

10. The system as in claim 9 wherein the plurality of selectable threshold levels includes a low throttle level of 25% or ¼, a medium throttle level of 50% or ½ and the high throttle level comprises 75% or ¾.

11. The system as in claim 10 wherein the multi-core processor disables the least recently used (LRU) hints when the current threshold level is set at a low throttle level, medium throttle level, or high throttle level.

12. The system as in claim 10 wherein the multi-core processor performs the additional operations of:
determining if the current prefetch detector has more than one demand pending; and
if not, then setting the current throttling threshold level to No Throttle.
